(19) United States
(12) Patent Application Publication
(10) Pub. No.: US 2016/0140580 A1
(43) Pub. Date: May 19, 2016

(54) CUSTOMER DEMOGRAPHIC INFORMATION SYSTEM AND METHOD

(71) Applicant: International Business Machines Corporation, Armonk, NY (US)

(72) Inventors: Seraphin B. Calo, Cortlandt Manor, NY (US); Vasileios Pappas, Elmsford, NY (US); Dinesh C. Verma, New Castle, NY (US); Petros Zerfos, New York, NY (US)

(21) Appl. No.: 14/932,287

(22) Filed: Nov. 4, 2015

Related U.S. Application Data
(63) Continuation of application No. 14/669,134, filed on Mar. 26, 2015.
(60) Provisional application No. 62/081,738, filed on Nov. 19, 2014.

(51) Int. Cl. G06Q 30/02

(52) U.S. Cl. CPC G06Q 30/0201

(57) ABSTRACT

The present disclosure relates generally to customer demographic information (e.g., monetizing customer demographic information). In various examples, obtaining, aggregating and/or providing customer demographic information may be implemented in the form of systems, methods and/or algorithms.

### CROSS REFERENCE TO RELATED APPLICATION

The present application is a continuation application of U.S. Ser. No. 14/669,134 filed Mar. 26, 2015, which claims the benefit of U.S. Provisional Patent Application Ser. No. 62/081,738 filed Nov. 19, 2014 the entire contents of which are incorporated by reference herein.

### BACKGROUND

Mobile network operators (MNOs) are typically looking for ways to monetize the data that is flowing through their networks (currently they typically just get the information from subscribers). Challenges that the MNOs face in monetizing data include: (a) Privacy Concerns: the MNOs cannot typically share personalized information or details about any one person; (b) Extracting information from data is costly: there is a need for managing (and billing) resources used for this purpose; (c) Useful Information: A lot of information that the MNOs have (e.g. radio characteristics) is typically not of use to anyone else; and (d) User Satisfaction Concerns: MNOs don't want to be seen as part of the group that causes spam to come to their subscribers.

Collecting information on how customers move about in a certain locality (the so called “foot traffic”) is a typically critical step in the planning and operation of any retail establishment. For example, the number of potential customers that visit a certain place at a given time of day, their profile (e.g. age, gender, etc.), the time that they spend in a certain locality and the frequency of visits, the interests that they have while in a certain area, are a just a few of many valuable pieces of customer information that are useful for planning and operating a retail establishment. Yet the process through which this information is collected is typically laborious, error-prone, and difficult to implement and update.

Typically, such information is obtained through either general traffic monitoring systems that are installed by transportation agencies for tracking the flow of vehicles, or through field surveys that are implemented by market research agencies. Both approaches do not typically provide accurate, detailed, timely and comprehensive customer flow information.

For example, general traffic monitoring systems typically provide only incomplete information that pertains to vehicles, potentially under-reporting the number of people that move through a particular area and their other demographic information (e.g. age, gender, etc.). Customer surveys, while more comprehensive and detailed, typically only track a sample of potential customers leading to errors in estimation, are very costly to conduct on a persistent basis for long periods of time and their geographical reach is also limited. Other approaches attempt to leverage the recent popularity of mobile devices and cellular phones, and install applications on the smart phone devices that report the location of the user (sometimes with his or her consent).

However, only a limited number of smart phone users may have these applications installed leading to inaccurate reporting, while this device-centric approach itself drains the battery of the mobile device, which provides a disincentive for adoption.

Additionally, the client-side application might only be supported on a limited type of mobile devices/operating systems, further reducing the sample of mobile users.

As described herein is a service that can be provided by mobile (e.g., cellular) networks that collects and makes available such information at large scale, in an accurate and comprehensive manner.

### SUMMARY

The present disclosure relates generally to customer demographic information (e.g., monetizing customer demographic information). In various examples, obtaining, aggregating and/or providing customer demographic information may be implemented in the form of systems, methods and/or algorithms.

In one embodiment, a method for providing, to an information requester, information associated with a plurality of mobile device users is provided, the method comprising: collecting, by a processor, from multiple data sources of a mobile network, mobile user information associated with the plurality of mobile device users; augmenting, by the processor, the collected mobile user information with data from at least one on-demand mobile network service; anonymizing, by the processor, the augmented mobile user information; aggregating, by the processor, the anonymized, augmented mobile user information along multiple dimensions to construct customer demographic information; computing, by the processor, a price for the customer demographic information; and providing, by the processor, to the requester, the customer demographic information.

In another embodiment, a computer program product for providing, to an information requester, information associated with a plurality of mobile device users is provided, the computer program product comprising a computer readable storage medium having program instructions embodied therewith, the program instructions executable by the computer to cause the computer to perform a method comprising: collecting, from multiple data sources of a mobile network, mobile user information associated with the plurality of mobile device users; augmenting the collected mobile user information with data from at least one on-demand mobile network service; anonymizing the augmented mobile user information; aggregating the anonymized, augmented mobile user information along multiple dimensions to construct customer demographic information; computing a price for the customer demographic information; and providing, to the requester, the customer demographic information.

In another embodiment, a computer-implemented system for providing, to an information requester, information associated with a plurality of mobile device users is provided, the system comprising: a collecting element configured to collect, from multiple data sources of a mobile network, mobile user information associated with the plurality of mobile device users; an augmenting element configured to augment the collected mobile user information with data from at least one on-demand mobile network service; an anonymizing element configured to anonymize the augmented mobile user information; an aggregating element configured to aggregate the anonymized, augmented mobile user information along multiple dimensions to construct customer demographic information; a computing element configured to compute a price for the customer demographic information; and a providing element configured to provide, to the requester, the customer demographic information.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram of a system architecture according to an embodiment of the present invention.

FIG. 2 depicts another block diagram of a system architecture according to an embodiment of the present invention.

FIG. 3 depicts a block diagram of processing of a demographic information request according to an embodiment of the present invention.

FIG. 4 depicts a block diagram of a process (in particular, an information request planner process) according to an embodiment of the present invention.

FIG. 5 depicts a block diagram of a process (in particular, a determining requirements for collecting additional demographic information process) according to an embodiment of the present invention.

FIG. 6 depicts a block diagram of a method according to an embodiment of the present invention.

FIG. 7 depicts a block diagram of a system according to an embodiment of the present invention.

FIG. 8 depicts a block diagram of a system according to an embodiment of the present invention.

### DETAILED DESCRIPTION

As described herein, various embodiments relate to mechanisms for monetizing customer demographic information. In various examples, obtaining, aggregating and/or providing customer demographic information may be implemented in the form of systems, methods and/or algorithms.

For the purposes of description the term “real-time” (e.g., as used in the context of real-time data) is intended to refer to cause and effect occurring approximately contemporaneously in time (e.g., without significant time lag between cause and effect but not necessarily instantaneously).

For the purposes of description, the term “historic” (e.g., as used in the context of historic data) is intended to refer to non-real-time (e.g., having a significant time lag between cause and effect (such as hours or days)).

For the purposes of description, the term “computational resources” is intended to refer to computing resources (e.g. CPU cycles) and/or storage resources (e.g. data volume) and/or network resources (e.g. bandwidth).

As described herein, various embodiments are implemented and deployed within a mobile (e.g., cellular) network provider infrastructure. Mechanisms may be provided for: (a) tapping into the various sources of information within the mobile network; (b) collecting, anonymizing, correlating, aggregating and providing this information; and (c) controlling the resources (e.g., sources of information) that provide the information.

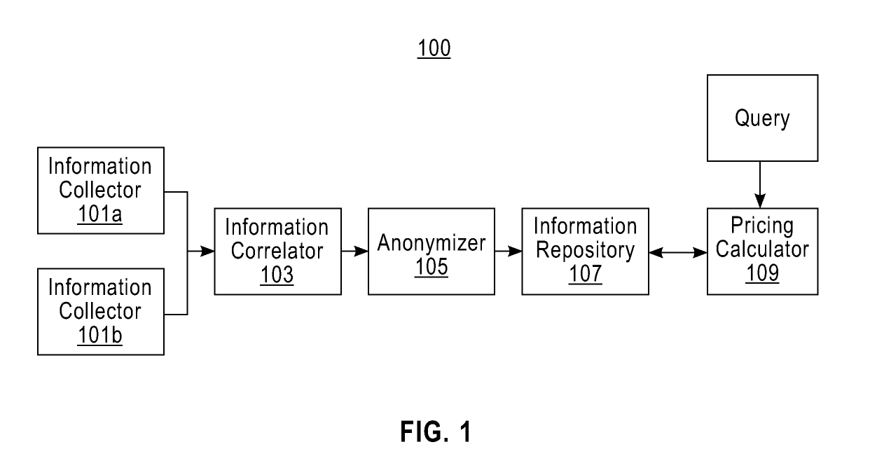

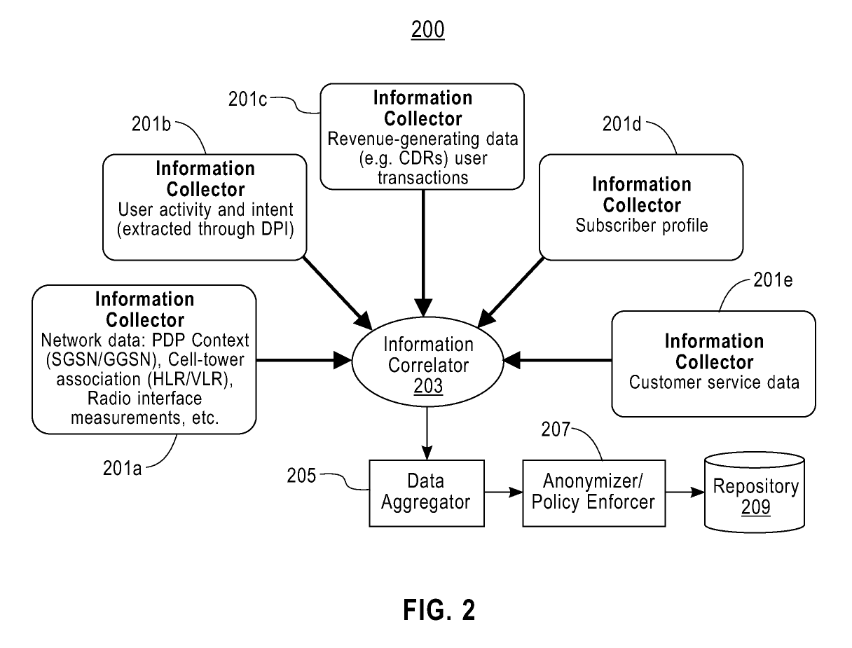

Referring now to FIG. 1, a high-level view of an example implementation according to an embodiment is shown. As seen in this FIG. 1, Information Collector 101a and Information Collector 101b are provided (details of such Information Collector mechanisms are provided below in connection with FIG. 2). Of note, while two Information Collectors are shown in this figure, any desired number of Information Collector(s) may be utilized. Further, Information Correlator 103 receives inputs from Information Collector 101a and Information Collector 101b (details of such an Information Correlator mechanism are provided below in connection with FIG. 2). Further, Anonymizer 105 receives input from Information Correlator 103 and sends data to Information Repository 107 (details of such Anonymizer and Information Repository mechanisms are provided below in connection with FIG. 2).

Still referring to FIG. 1, it is seen that Pricing Calculator 109 (which receives a query), interfaces with Information Repository 107 in order to determine a price to be charged to answer the query (details of such a Pricing Calculator mechanism are provided below in connection with FIG. 2).

Referring now to FIG. 2, another high-level view of an example implementation according to an embodiment is shown. As seen in this FIG. 2, a plurality of Information Sources are provided. In this example, five Information Sources—identified as Information Collectors 201a-201e are provided (of note, while five Information Collectors are shown in this figure, any desired number of Information Collector(s) may be utilized). Each of these Information Collectors taps into the various sources of user information that are used in the cellular network environment. As seen in this Fig., these include (but are not limited to): (a) the home and visitor location registrar (HLR/VLR), where information about the cell that the user is associated with is stored; (b) the subscriber database that stores subscriber data such as personal and credit customer profile, device and plan used, service selections and preferences; (c) the billing database that includes Call Detail Records (CDRs) with billing information and location of the users; (d) the network monitoring database, which stores KPIs (Key Performance Indicators) regarding user connectivity; and (e) the GGSN/SGSN and other network elements of cellular network provider where the assignment of IP addresses to mobile users is performed (the Packet Data Protocol (PDP) Context). Source(s) of user information might also include other cellular services and functions that might not store permanently user information but can extract it while it is being transmitted through the cellular network. Such functions include, for example, deep packet inspection (DPI), that is able to extract and analyze user traffic (for example the text of an HTML page that the user is accessing through his or her mobile device). Such functions may also include the localization service of the cellular network provider, that is able to localize the user at a finer granularity than cell site ID, at a higher computational cost than simply quering the HLR/VLR location registrar.

Still referring to FIG. 2, it is seen that Information Correlator 203 is provided. This module is responsible for correlating the information that is collected from the various sources into a single, holistic view of each user. The Information Correlator makes results for demographics more accurate as it reconciles data from various sources into a single view, avoids double counts of information (de-duplication), and eliminates incorrect information (e.g. stale information regarding the location of a user). A variety of mobile user identifiers are correlated with one another, including IP (Internet Protocol) addresses, IMEI (International Mobile Equipment Identifier) numbers, IMSI (International Mobile Subscriber Identifier) numbers, account numbers used for billing, etc.

Still referring to FIG. 2, it is seen that Data Aggregator 205 is provided. This Data Aggregator module is responsible for calculating various aggregate, descriptive statistics on the data that is collected. The aggregation/statistics may, in one example, be based on multiple-dimensions (e.g., min, max, median, distributions, etc). These may include spatial (e.g., block, neighborhood, city, etc.) dimensions and/or temporal dimensions (e.g., hourly, daily, weekly, etc.). Other dimensions may include dimensions extracted from user profiles (e.g. age). A multi-dimensional data warehouse (see, e.g., Repository 209) can be used to store materialized historical information for easy retrieval to most frequent queries. However, in case data is collected “on-the-fly” and is not pre-stored in any of the sources (e.g. user interests and/or intents extracted from inspecting user traffic through deep packet inspection), then only these queries are not materialized but are computed on the fly.

Still referring to FIG. 2, it is seen that Anonymizer/Policy Enforcer 207 is provided. This Anonymizer/Policy Enforcer module is tasked with ensuring that the data that is returned as a reply to a demographics query preserves the anonymity of the cellular network users. This module ensures that enough data points are used on a given dimension (e.g., geographical area) for aggregation, so to avoid accidentally leaking the identities of individuals. Also, in case a user has opted-out from or restricted the use of his or her data, this module removes any such data collected from any subsequent processing. Also, any policies that might need to be enforced regarding the use of such demographic data (e.g., exclusion of certain government areas from the results) are handled by this subsystem.

With respect to how the module ensures that enough data points are used in a given dimension for aggregation, in various examples there are several algorithmic data mining techniques that may be used for ensuring privacy of user data. One of the well-known references in this particular area, which also provides methods for quantifying the information-privacy trade-off (e.g. calculating aggregate values that are representative of the underlying distribution given a certain level of information-loss), is: “On the Design and Quantification of Privacy-Preserving Data Mining Algorithms”, by Dakshi Agrawal and Charu Aggarwal, which appeared in ACM PODS 2001. A technique such as those described therein can be used to provide a quantification on the amount of data points that is needed in order to calculate aggregate values without accidentally leaking identities of individuals.

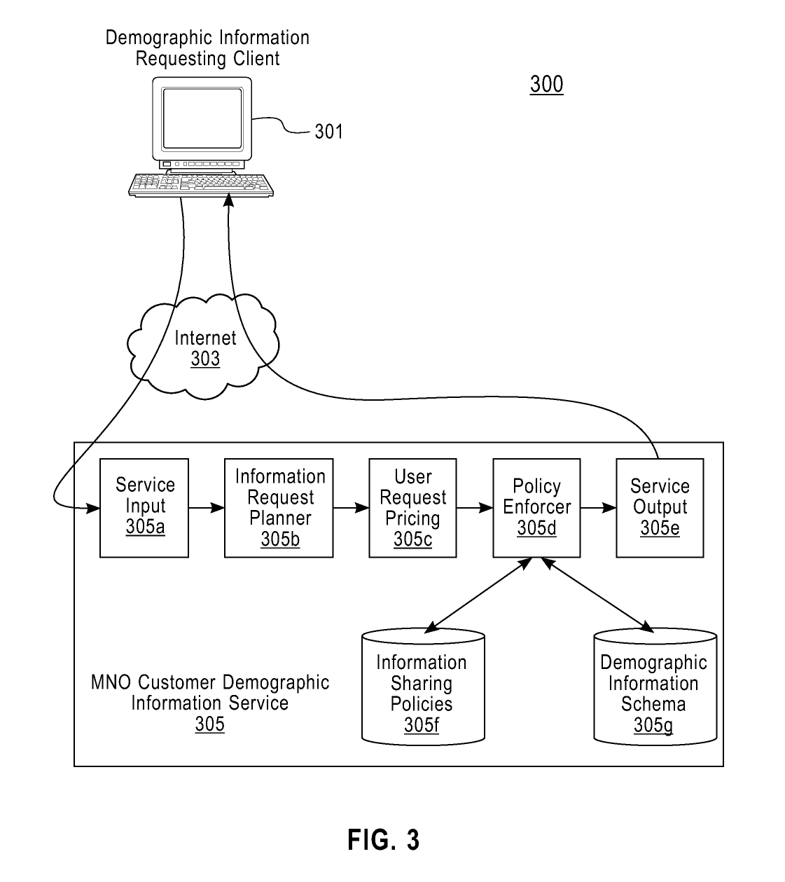

Referring now to FIG. 3, another high-level view of an example of processing of a demographic information request is provided. As seen in this FIG. 3, Demographic Information Requesting Client 301 makes request(s) for information via, for example, Internet 303. In this example, the request from Demographic Information Requesting Client 301 is received by Service Input 305a of MNO Customer Demographic Information Service 305). This Service Input 305a (which acts as an input request module) accepts the request for customer demographic information from a user, through a variety of interfaces that might include (but not be limited to) SQL, Web-Services (REpresentational State Transfer Application Programming Interface (REST API)), JavaScript Object Notation (JSON) or other formats and languages.

Still referring to FIG. 3, it is seen that Information Request Planner 305b is provided. This Information Request Planner 305b is responsible for estimating the resources (e.g., sources of information and/or computational resources) needed for answering a given user request, based on the type of data that was requested, the request's level of granularity, the geographical and temporal reach of the request, and any special information that might be requested (e.g. user interests, sentiment, etc.). As some of this information is computed on the fly and might require significant computational resources that are based on the range of information that is requested (e.g., identifying mobility patterns for mobile users that move within a block vs. mobile users that roam within a city), the Information Request Planner 305b identifies the resources (e.g., sources of information and/or computational resources) and employs pre-computed cost models regarding the use of these resources. Additionally, the Information Request Planner 305b takes into account the current state of the cellular network by communicating with a network management/traffic monitoring system, in order to assess whether the cellular network has enough capacity to run such query (e.g., if it has sufficient computational resources at a given time for analyzing traffic traces of users in a neighborhood). The Information Request Planner 305b provides these estimates to the User Request Pricing module 305c discussed below (as well as, for example, the Information Collectors 201a-201e and the Data Aggregator 205).

In various embodiments, the Information Request Planner 305b analyzes the demographic information request (i.e. query) that it receives through some interface (e.g. REST API, web form, SQL-like language, or some other format). This request/query can have parameters that specify both the type of information that is being requested, e.g. number of users, types of websites/information that the users access on their mobile phones, as well as constraints (or filters) that the data used to answer the query has to satisfy. Such constraints might include geographic regions of interest (e.g. within a certain city, around 5 blocks from a given location, travelling through a particular route, etc.), time constraints (e.g. between 9 am-5 pm on working days, in the weekends, on Labor day, etc.), as well as any other type of demographics information that might be made available for queries. The type of information requested in the query and the constraints imposed onto it can be then used to identify the resources that are needed to answer it. For example, if the query requests the number of users present in a given area during a time-interval in the day, then only network data sources such as PDP context and cell-tower association of users might be sufficient to answer it. If, in another example, the request for demographic information requires also the profile of the users (e.g. male/female ratio, distribution of users according to their home zip code, etc.), then additional information from the subscriber profile database of the telecommunications services provider (i.e. another resource) will need to be accessed. Further, if the request for demographics information asks for the topics that the users are typically interested in on a given geographic region and time, then the DPI (i.e. Deep Packet Inspection) resource will be needed, which typically runs only on-demand, due to high load that it imposes on the telecommunication services provider infrastructure.

Once the resources that will be needed to satisfy a given query (i.e. a given demographics information request) have been identified, then pre-computed cost models are employed to estimate the cost for answering that query. For example, if the identified resources only include data already stored into a database, such as information pertaining to user association (to a cell-tower), then cost models for database queries are used (e.g. based on how many rows are accessed from the database, amount of data in bytes that are retrieved, etc.). If on-demand data sources (such as Deep Packet Inspection) are used, then cost models that pertain to computing resources needed for retrieving (or extracting) that information are used, such as volume of traffic that is expected to be analyzed (based on historical measurements), CPU cycles needed for inspecting user traffic, etc. The particular cost model that is employed depends on the data source that has been identified as required in order to answer a given query. Finally, the information request planner retrieves available capacity values from the monitoring/management system of the cellular network, in order to assess whether there exist enough computational resources to answer the query in the first place. For example, if the application processor of the Deep Packet Inspection function is already highly loaded due to either running other demographic information queries or due to network/service monitoring operations that it currently performs to ensure the smooth functioning of the cellular infrastructure, then it might be able to answer the new demographic information query or not. This is communicated to the Information Request Planner so as to make appropriate adjustments to the cost models.

In various embodiments, the Information Request Planner 305b assesses the sources to be accessed (e.g., sources of information), the volume of information that is requested, freshness, frequency and coverage and estimates the processing requirements that are needed to satisfy the request/query. In various specific examples, the decisions of the Information Request Planner may be made based on request criteria (including, but not limited to): (a) Type of data that was requested (e.g. population age, income level); (b) Level of geographical and/or temporal granularity (e.g. quarter-mile spatial resolution, hourly population estimates); (c) Geographical and/or temporal coverage (e.g. over a set of counties, spanning 3 months); (d) Data freshness (e.g. data collected over at most last 6 months); and/or (e) Any special information that might be requested (e.g. user interest(s), user intent(s), user sentiment, etc.).

With respect to the request criteria, such request criteria may involve both the type of information that is requested in a query, as well as the constraints (i.e. filters) that the data used for answering that query should satisfy. For example, in the demographic information request: “provide me with the average number of users that are located for more than 30 minutes between the hours of 9 am and 12 noon in Times Square, New York City every work day in June”, the criteria would refer to “number of users” (type of data requested), “located in Times Square, New York City” (spatial coverage), “for more than 30 minutes” (temporal granularity), “between 9 am-12 am every work day in June” (temporal coverage). Note that, although this specific example was expressed in natural language, it could have been expressed in a more formal (and constrained) language such as SQL extension (to accommodate spatial query expressions—“located in . . . ”), or some other format. The information request planner can check if that same query has been already been answered, in which case the cost is known and the results can be readily retrieved if it has been materialized, otherwise it uses some query cost model (an example of an spatio-temporal query cost model can be found in “The TPR*-tree: an optimized spatio-temporal access method for predictive queries”, by Yufei Tao, Dimitris Papadias, Jimeng Sun, in proceedings of 29^{th} International Conference of Very Large Databases, VLDB 2003) to estimate the resources (e.g. disk accesses) needed to answer it.

Referring now to the User Request Pricing module 305c, this subsystem handles the pricing aspect of the user request regarding demographic information. It quotes a price for the request with any constraints that might be attached (e.g., estimates of reply time, conditions for abandoning, etc.), handles the billing of the requesting user, and refunds etc. that might be needed. It may also provide alternative options regarding queries and pricing options.

With respect to alternative options regarding queries and pricing, such alternative options may include queries for which answers are already available (e.g., because they had already been requested by other customers) or because the resources that these query alternatives require to be answered can be assigned at the given time as opposed to the original query. Such alternative queries might suggest a different granularity level for some dimension, or a different coverage, or even freshness. For example, alternative options to the query “provide me with the daily average number of users in past 6 months that spend more than 1 hr in Times Square, New York City” can be: “provide me with weekly average number of users in the past 6 months that spent more than 1 hr in Times Square, NYC” (alternative temporal granularity), or “provide me with the average number of users in the past 6 months that spent more than 1 hr in Midtown, NYC” (alternative spatial coverage), or “provide me with the daily average number of users in past 3 months that spent more than 1 hr in Times Square, New York City” (alternative freshness), or some combination of the above.

Referring now to the Policy Enforcer 305d, this module interacts with Information Sharing Policies Database 305f and Demographic Information Schema Database 305g to ensure that the data that is returned as a reply to a demographics query preserves the anonymity of the cellular network users. This module ensures that enough data points are used on a given dimension (e.g., geographical area) for aggregation, so to avoid accidentally leaking the identities of individuals. Also, in case a user has opted-out from or restricted the use of his or her data, this module removes any such data collected from any subsequent processing. Also, any policies that might need to be enforced regarding the use of such demographic data (e.g., exclusion of certain government areas from the results) are handled by this subsystem.

Finally, as seen, the Service Output module 305e handles the delivery of the results (e.g., requested demographic information) back to the user through some data interchange mechanism (e.g., that has been pre-agreed upon with the requesting user).

With respect to the data interchange format, such data interchange format typically depends on the method provided for issuing the query to the demographic information service. If a REST (Representation State Transfer) API (Application Programming Interface) has been used to access the service, then data can be returned as JSON (JavaScript Object Notation)-formatted string over HTTP (HyperText Transfer Protocol) or as an XML (eXtensible Markup Language)-formatted string, again over HTTP. Data can be returned in a CSV (comma-separated values) file, or as a set of records as specified in the JDBC (Java DataBase Connectivity) protocol, wherein SQL (Structured Query Language) queries can be issued directly to a database.

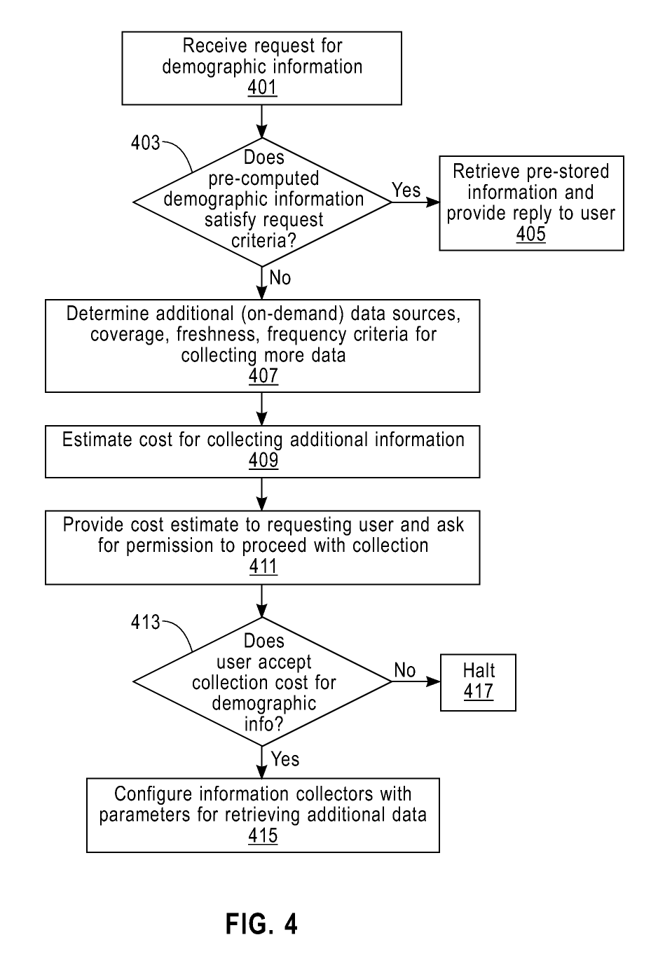

Referring now to FIG. 4, a block diagram of an information request planner process according to an embodiment of the present invention is shown. As seen in this FIG. 4: Step 401 is to receive a request for demographic information; Step 403 is to determine whether pre-computed demographic information satisfies the request criteria (if YES, then processing proceeds to Step 405, which retrieves pre-stored information and provides a replay to the user; if NO, then processing proceeds to Step 407); Step 407 is to determine, based on criteria (e.g., coverage, freshness, frequency) additional (on-demand) data sources (e.g., sources of information) for collecting more data; Step 409 is to estimate the cost for collecting additional information; Step 411 is to provide the cost estimate to the requesting user and ask for permission to proceed with collection; Step 413 is to determine whether the user accepts the collection cost for the demographic information (if YES, then processing proceeds to Step 415, which configures Information Collector(s) with parameter(s) for retrieving additional data; if NO, then processing halts at Step 417). In one specific example, Step 401 may be carried out by service input 305a of FIG. 3 and Step 403 may be carried out by information request planner 305b of FIG. 3.

With respect to how additional on-demand data sources are determined, such additional on-demand data sources may be determined by the type of information that is requested by the query, the freshness criteria that has been specified, as well as whether the requested information already exists in some data storage facility of the telecommunication service provider or not. For example, if the type information that is requested includes the website topics that are visited most frequently by mobile users in a given location and time, then this information might not exist in the database for that given location, at which point data collection has to be initiated (on-demand sources for “shallow” extraction of website URL (Uniform Resource Locator)). Similarly, if the aggregate sentiment of users that visit a given web forum at the current moment is requested (freshness criterion), then the sentiment analysis module has to start analyzing data traffic directed to that web forum, and the source is determined. In general, the determination of the sources that are needed to answer a given demographics information request is determined by the components of the request itself, as well as what is already available in the data storage facility.

With respect to parameters for retrieving additional data, each information collector may have several parameters that can be tuned according to the requirements that the demographic information request has with respect to the type of information to be collected and the characteristics that it should have. For example, for a deep packet inspection (DPI) information collector, parameters might include sampling rate (in case only approximate demographic information is requested), coverage criteria such as cell-towers to inspect traffic from, range of IP-addresses for sources, specific web sites and applications/service visited, etc. Similarly, the collector pertaining to customer service data might be configured to return error messages automatically reported by mobile users (more specifically: the mobile devices of users) pertaining to a specific service that the users are accessing, such as failures to access a web site.

With respect to costs for collecting additional information, such costs for collecting additional information may be computed based on historical measurements regarding consumption of resources that is needed in order to satisfy a query, given some freshness, coverage and frequency criteria. For example, if analysis of the aggregate sentiment regarding a topic of a given profile of users in a locality and time is requested, then the system can estimate, based on historical data how many users are expected to be present in the locality and given time interval, how much traffic is expected to be generated by said users and, based on this information, calculate the CPU, bandwidth and storage requirements that are needed from one or more given sources in order to extract and calculate the aggregate sentiment from said traffic. Based on the estimated resources that are needed, a cost can be calculated and presented to the user.

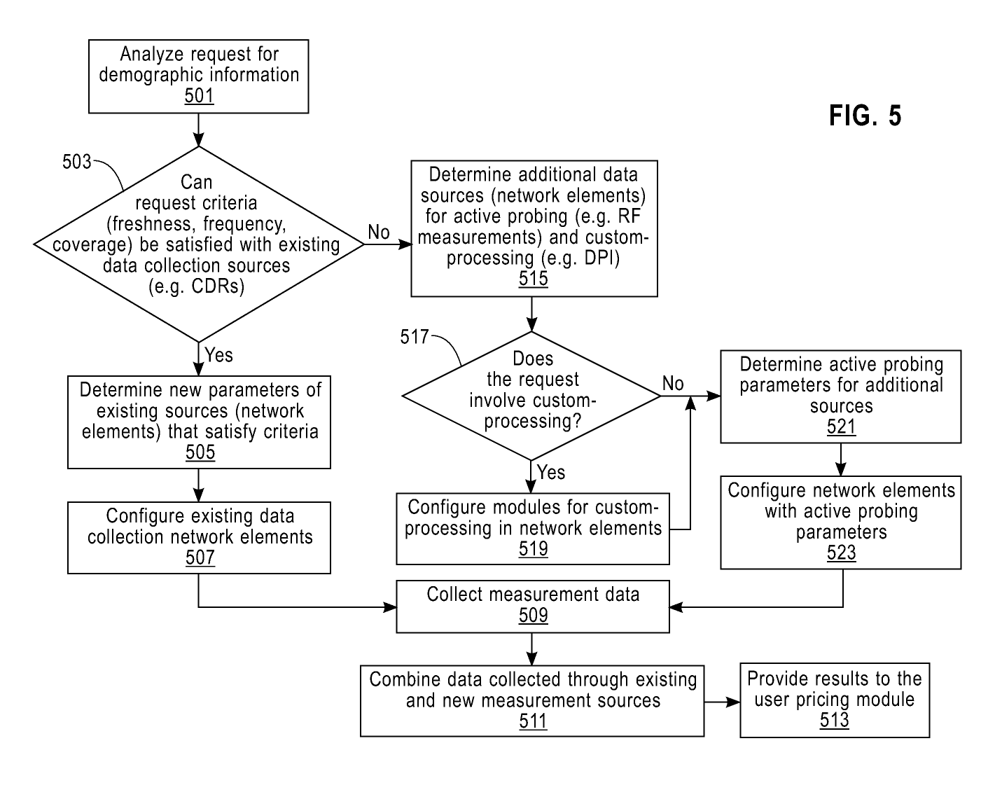

Referring now to FIG. 5, a block diagram of a determining requirements for collecting additional demographic information process according to an embodiment of the present invention is shown. As seen in this FIG. 5, Step 501 is to analyze the request for demographic information; Step 503 is to determine whether the request criteria (e.g., coverage, freshness, frequency) can be satisfied with existing data collection sources (e.g., call data records) (if YES, then processing continues to Step 505; if NO, the processing continues to Step 515).

Still referring to FIG. 5, Step 505 is to determine new parameters of existing sources (network elements) that satisfy the criteria; Step 507 is to configure existing data collection elements; Step 509 is to collect measurement data from the measurement sources; Step 511 is to combine measurement data collected through existing and new (as applicable—see Steps 515, 517, 519, 521, and 523 discussed below) measurement sources; and Step 513 is to provide results to the user pricing module (see, e.g., 305c of FIG. 3).

With respect to configuration of existing data collection elements, such existing data collection elements may refer to network/service elements that continuously collect information (e.g. CDR collection and storage systems) for the whole network, and which can be configured through appropriate parameters to retrieve information that satisfies certain freshness, frequency and coverage criteria that the demographic information request has. For example, for a request that has certain freshness requirements in a given locality, the collection elements for CDRs in that locality can be configured to report information from CDRs (e.g. length of calls) on a minute-by-minute basis, as opposed to every hour, which would be for normal operating conditions (e.g. for billing purposes). Once the demographic information request has been answered, then the parameters of the collection process can return back to normal operating conditions.

With respect to new measurement sources, such new measurement sources may include those that are not employed on a continuous basis as part of the normal operating configuration of the network/service. For example, due to very high processing, communication and storage costs, Deep Packet Inspection (DPI) is employed only occasionally, for example when resolution of a service outage is needed or when a deeper look into the operation of the service is needed for optimization purposes. However, if there is a request for demographic information that requires information that is not recorded as part of the normal operating process of the network, neither has it been pre-computed and stored due to a prior query/request, then a new source has to be added in order to satisfy/compute an answer for this new request.

Still referring to FIG. 5, Step 515 is to determine additional data sources (network elements) for active probing (e.g., RF measurements) and/or custom processing (e.g., deep packet inspection); Step 517 is to determine whether the request involves custom processing (if YES, then processing continues to Step 519; if NO, then processing continues to Step 521).

Still referring to FIG. 5, Step 519 is to configure modules for custom-processing in network element(s); Step 521 is to determine active probing parameters for additional sources(s); Step 523 is to configure network element(s) with active probing parameters. After Step 523, the process continues to Steps 509, 511 and 513, as discussed above.

With respect to active probing parameters, such active probing parameters may include those parameters that pertain to the configuration of measurement elements (e.g., RF (Radio Frequency) measurement systems) that require the element, network, or service management system to introduce network traffic for the explicit purpose of performing such measurements. For example, to identify whether a particular service is available, the service management system may initiate test connections to a server that offers a given service, in order to assess whether the server is “alive” and accessible and whether the software that provides that service is up and running on that server. For example, REST requests for testing purposes from a given part of the network might be initiated to a REST server performing geo-coding functions (geo-coding being conversion of a geographic coordinate expressed in latitude-longitude to an actual street address and vice versa). Another example of an active probing parameter that is configured on a network management system is for the purposes of determining the available communication bandwidth that a mobile user can enjoy at a given cell tower and point in time-active network bandwidth measurement requests (also known as “packet trains”) can be sent in that cell-tower to determine its available bandwidth.

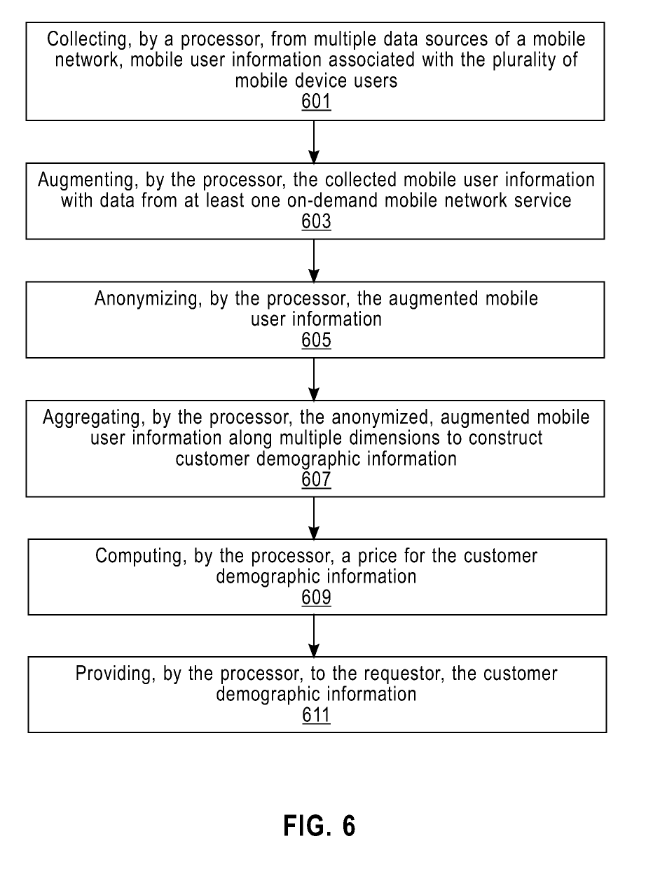

Referring now to FIG. 6, an automatic method for providing, to an information requester, information associated with a plurality of mobile device users is shown. As seen in FIG. 6, the method of this embodiment comprises: at 601—collecting, by a processor, from multiple data sources of a mobile network, mobile user information associated with the plurality of mobile device users; at 603—augmenting, by the processor, the collected mobile user information with data from at least one on-demand mobile network service; at 605—anonymizing, by the processor, the augmented mobile user information; at 607—aggregating, by the processor, the anonymized, augmented mobile user information along multiple dimensions to construct customer demographic information; at 609—computing, by the processor, a price for the customer demographic information; and at 611—providing, by the processor, to the requester, the customer demographic information.

In another example, any steps may be carried out in the order recited or the steps may be carried out in another order.

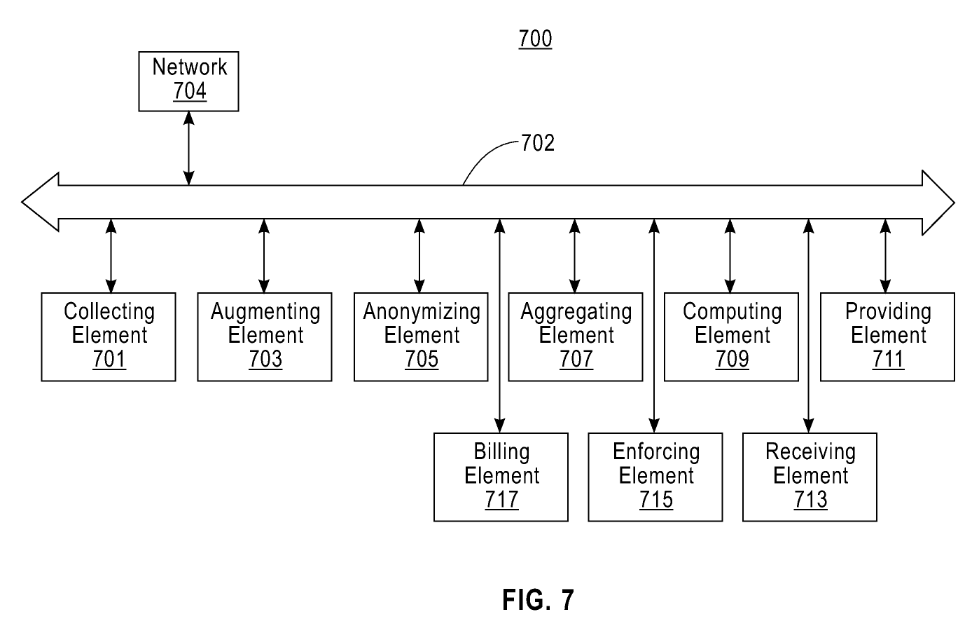

Referring now to FIG. 7, in another embodiment, a computer system 700 for providing, to an information requester, information associated with a plurality of mobile device users is provided. This computer system may include the following elements: a collecting element 701 configured to collect, from multiple data sources of a mobile network, mobile user information associated with the plurality of mobile device users; an augmenting element 703 configured to augment the collected mobile user information with data from at least one on-demand mobile network service; an anonymizing element 705 configured to anonymize the augmented mobile user information; an aggregating element 707 configured to aggregate the anonymized, augmented mobile user information along multiple dimensions to construct customer demographic information; a computing element 709 configured to compute a price for the customer demographic information; and a providing element 711 configured to provide, to the requester, the customer demographic information.

Further, this computer system may include the following elements: a receiving element 713 configured to receive, from the requester, a request for the customer demographic information; an enforcing element 715 configured to enforce policies regarding use of the mobile user information based on mobile user preferences; and a billing element 717 configured to bill the requester for the customer demographic information.

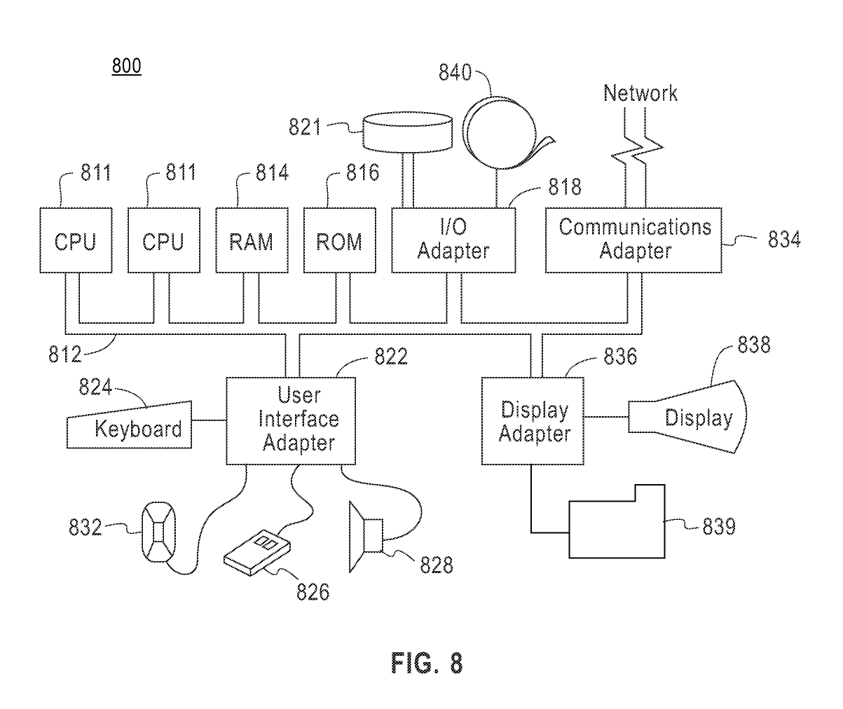

Still referring to FIG. 7, each of the elements may be operatively connected together via system bus 702. In one example, communication between and among the various elements may be bi-directional. In another example, communication may be carried out via network 704 (e.g., the Internet, an intranet, a local area network, a wide area network and/or any other desired communication channel(s)). In another example, some or all of these elements may be implemented in a computer system of the type shown in FIG. 8.

Referring now to FIG. 8, this figure shows a hardware configuration of computing system 800 according to an embodiment of the present invention. As seen, this hardware configuration has at least one processor or central processing unit (CPU) 811. The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communications adapter 834 for connecting the system 800 to a data processing network, the Internet, an Intranet, a local area network (LAN), etc., and a display adapter 836 for connecting the bus 812 to a display device 838 and/or printer 839 (e.g., a digital printer or the like).

In one embodiment, a method for providing, to an information requester, information associated with a plurality of mobile device users is provided, the method comprising: collecting, by a processor, from multiple data sources of a mobile network, mobile user information associated with the plurality of mobile device users; augmenting, by the processor, the collected mobile user information with data from at least one on-demand mobile network service; anonymizing, by the processor, the augmented mobile user information; aggregating, by the processor, the anonymized, augmented mobile user information along multiple dimensions to construct customer demographic information; computing, by the processor, a price for the customer demographic information; and providing, by the processor, to the requester, the customer demographic information.

In one example, the method further comprises receiving, by the processor, from the requester, a request for the customer demographic information.

In another example, the method further comprises enforcing, by the processor, policies regarding use of the mobile user information based on mobile user preferences.

In another example, the method further comprises billing, by the processor, the requester for the customer demographic information.

In another example, each mobile device is selected from the group comprising: (a) a mobile telephone; (b) a smart phone; (c) a tablet; (d) a notebook computer; (e) a netbook computer; (f) a wearable; or (g) an combination thereof.

In another example, the at least one on-demand mobile network service is selected from the group comprising: (a) deep packet inspection; (b) a user localization; or (c) any combination thereof.

In another example: the collecting from multiple data sources comprises collecting historic data from the multiple data sources; and the at least one on-demand mobile network service provides real-time data.

In another example, the mobile network is a cellular network.

In another embodiment, a computer program product for providing, to an information requester, information associated with a plurality of mobile device users is provided, the computer program product comprising a computer readable storage medium having program instructions embodied therewith, the program instructions executable by the computer to cause the computer to perform a method comprising: collecting, from multiple data sources of a mobile network, mobile user information associated with the plurality of mobile device users; augmenting the collected mobile user information with data from at least one on-demand mobile network service; anonymizing the augmented mobile user information; aggregating the anonymized, augmented mobile user information along multiple dimensions to construct customer demographic information; computing a price for the customer demographic information; and providing, to the requester, the customer demographic information.

In one example, the program of instructions, when executing, further performs the step of receiving, from the requester, a request for the customer demographic information.

In another example, the program of instructions, when executing, further performs the step of enforcing policies regarding use of the mobile user information based on mobile user preferences.

In another example, the program of instructions, when executing, further performs the step of billing the requester for the customer demographic information.

In another example, each mobile device is selected from the group comprising: (a) a mobile telephone; (b) a smart phone; (c) a tablet; (d) a notebook computer; (e) a netbook computer; (f) a wearable; or (g) an combination thereof.

In another example, the at least one on-demand mobile network service is selected from the group comprising: (a) deep packet inspection; (b) a user localization; or (c) any combination thereof.

In another example: the collecting from multiple data sources comprises collecting historic data from the multiple data sources; and the at least one on-demand mobile network service provides real-time data.

In another example, the mobile network is a cellular network.

In another embodiment, a computer-implemented system for providing, to an information requester, information associated with a plurality of mobile device users is provided, the system comprising: a collecting element configured to collect, from multiple data sources of a mobile network, mobile user information associated with the plurality of mobile device users; an augmenting element configured to augment the collected mobile user information with data from at least one on-demand mobile network service; an anonymizing element configured to anonymize the augmented mobile user information; an aggregating element configured to aggregate the anonymized, augmented mobile user information along multiple dimensions to construct customer demographic information; a computing element configured to compute a price for the customer demographic information; and a providing element configured to provide, to the requester, the customer demographic information.

In one example, the system further comprises a receiving element configured to receive, from the requester, a request for the customer demographic information.

In another example, the system further comprises an enforcing element configured to enforce policies regarding use of the mobile user information based on mobile user preferences.

In another example, the system further comprises a billing element configured to bill the requester for the customer demographic information.

In other examples, any steps described herein may be carried out in any appropriate desired order.

As described herein, various embodiments may be applied in the context of: (a) mobile and wireless networking; and/or (b) telecommunication networks.

As described herein, various embodiments provide a mechanism for cellular network operators to aggregate and anonymize their user demographic information in combination with user movement patterns in order to monetize this data (e.g., by selling the data to third parties).

As described herein, various embodiments provide a mechanism for anonymizing mobile user information collected from multiple sources to be provided as aggregate demographic information.

As described herein, various embodiments provide a mechanism for estimating a cost for constructing an answer to a given query for aggregate demographic information based on various criteria such as, for example, freshness, frequency and/or coverage.

With respect to how costs are estimated for constructing an answer, as mentioned above, the cost for constructing an answer may be estimated, for example, through: a) the identification of the sources that are needed in order to answer the given demographic information request; b) the computational, communication, and storage resources that are needed to process and analyze the information from these sources; and c) an aggregate function that is applied to estimate the overall cost of the query based on the multitude of sources (and resources) that are needed for its answer.

As described herein, in various embodiments a cellular network provider installs a server in its network that collects, anonymizes, correlates and aggregates user information from a variety of sources (e.g., sources of information) and databases in its network, including (but not limited to): the network's home location registrar, deep packet inspection function, subscription profile database, Element Management System (EMS) agents, etc. The server may provide a REST API through which it can accept queries on this information and return the results to one or more third party clients. The server may also include functionality for deciding on the conditions to be met for using sources (e.g., sources of information) that might incur high computational overhead from the network in order to answer certain queries (see, e.g., user request pricing module 305c of FIG. 3), for example, the localization service, or a keyword matching module used for analyzing user traffic for user intent and activity. A billing subsystem (see, e.g., user request pricing module 305c of FIG. 3) can dynamically set the price for the query, based on the types of the queries that are requested.

With respect to deciding on the conditions to be met for using certain sources, such decisions may depend, for example, on: a) whether the network/service element that is used to process that source has available capacity to satisfy the query given its resource utilization levels at a given time (for example due to normal operating tasks); and b) the policies that might apply regarding its use for answering a query (for example, regulatory restrictions due to government requirements, etc.). The former (a) can be decided based on information that is collected from the network and service monitoring system of the telecommunication services provider, by examining utilization levels and available (residual) capacity of the network elements that are needed to collect and analyze information from a given source. The latter (b) can be decided using explicit policies and a rule-based system (e.g. jRules).

With respect to setting the prices dynamically, there are various methods for performing such dynamic setting of a price, including (but not limited to): auctions (amongst multiple requesters for customer demographic information); resource-driven estimation (availability of existing resources for collecting and analyzing information requested), etc.

In various examples, advantages of disclosed mechanisms pertain to the ability to cover a large geographical area (in which typically Tier-1 cellular network(s) provide coverage) along with the ability to provide comprehensive and detailed results that can be collected due to its reach and scope, as well as the ability to cover a population with diverse mobile devices, applications that are installed and online services that are accessed. Also, mechanisms may be provided the ability to continuously monitor, collect and make available this information in an automated manner.

As described herein, various embodiments may provide for customer demographic information as a service (e.g. a Mobile Network Operator Data Monretization Service). In one specific example, the customer demographic information may be used for tracking patterns for retail operators.

In another example, various embodiments may be implemented in the context of retail stores. In this regard, retailers typically want to obtain information about such things as: (a) How is my store doing relative to other competitors in the area; (b) How much time do people spend in my store; (c) How many people drive by my store every day; (d) Who are these people.

An MNO can provide this information to a retailer using mechanisms disclosed herein including, but not limited to: (a) a mechanism providing a privacy and anonymity structure; and (b) a mechanism providing management of costs and resources (e.g., sources of information and/or computational resources) associated with providing this information.

With respect to the provision of information, various general mechanisms for providing customer demographic information to a retailer may follow the steps that are described herein. For example, if a retailer is interested in obtaining information about “the profile of the people that are found near her store on a given day”, the service provider may combine information from two sources: the CDRs (call detail records) database, that includes fields such as location of user and time stamp when the user was associated with the micro cell-tower located at or near the store of the retailer, as well as the customer subscriber database of the customer, that includes demographic information such as age, home location, male/female, etc. Based on the number of distinct users that it finds along the various categories it can make a decision on whether to include them in the calculation of the aggregates. For example, if non-adult users (children) have been located near the retailer's store, these might be excluded from the aggregate calculation to protect their privacy (for example, if only a very small number of children are found in an area). Rules and privacy-quantification techniques can be used for such purpose. Then, then an estimate of the cost for that query can be provided to the user. For example, the number of CDR records that had to be retrieved in order to answer that query as well as the number of records from the subscriber database, the time it took to retrieve that information, or the data volume that the answer consists of and would have to be transferred to the user.

In another example, an Information Correlator (see, e.g., Information Correlator 203 of FIG. 2) correlates user information from sources (e.g., sources of information) that make use of different identifiers (e.g., HLR/VLR location database: IMEI/IMSI; SGSN/GGSN: Internet Address; Subscriber Profile Database: User name, payment identifier).

In another example, an Information Correlator (see, e.g., Information Correlator 203 of FIG. 2) avoids double-counts and maintains consistency for the Data Aggregator (see, e.g., Data Aggregator 205 of FIG. 2).

With respect to double-counts, such double-counts may be avoided by correlating the various user and device identifiers that are used in the various collectors. For example, the SGSN/GGSN network elements (that terminate the mobile Internet connections in cellular network) make use of IP address, while the Home/Visitor Location Registrar uses the IMSI (International Mobile Subscriber Identifier) to uniquely identify a user. When a mobile user registers with a network, then she is assigned a temporary IP address that can change at a later time; this information is stored in the GGSN. Yet another network element, Deep Packet Inspection (DPI) might keep information on content accessed using only IP addresses that it extracts from the IP packets. When a request for customer demographic information is received, the service provider has to correlate all these databases, for example, to avoid double-counting of users interested in a given topic/intend for example due to two IP addresses having been assigned to same user.

As described herein, various embodiments focus on managing resources (e.g., sources of information and/or computational resources) and billing associated with providing timely as well as comprehensive (spatially and semantically) customer demographic information to client requests/queries. In one specific example, for advertisements, it's not just location estimates but also subscriber information, active location probing and custom-processing (e.g. user interests/intent as extracted from deep packet inspection analysis)

As described herein, in one example, some information might be pre-computed but other information might be retrieved only on-demand and/or through custom-processing (e.g., daily user mobility patterns in an area (pre-computed) vs. number of users with a certain age and income profile that are interested in sports cars (on-demand/custom-processing).

As described herein, various mechanisms provide accurate and comprehensive customer demographic information. Such mechanisms may include: (a) Collecting and correlating mobile user information from multiple data sources (e.g., sources of information) of a cellular network; (b) Augmenting the mobile user information with data from on-demand cellular network services (such as deep packet inspection, user localization, etc.); (c) Anonymizing and enforcing policies regarding data use based on mobile user preferences; (d) Aggregating the data along multiple dimensions to construct customer demographic information; (e) Computing a price and billing the requester of such customer demographic information; and/or (f) Presenting the aggregate, anonymized customer demographic information to the requester.

In another embodiment, a mechanism for providing aggregate and timely information on mobile users is provided as follows: (A) Collecting real-time information on mobile users, including location and movement; (B) Potentially augmenting the mobile user information with data from on-demand cellular network services such as deep packet inspection, user localization, etc. (e.g., to identify user interests and intents); (C) Anonymizing and enforcing policies regarding data use based on mobile user preferences; (D) Aggregating the information on individual mobile users as follows: (1) Along multiple dimensions (e.g., time, age, interest, etc.); (2) Along user mobility patterns; and/or (3) Across different granularities; (E) Correlating mobile user information from multiple data sources (e.g., sources of information) of a cellular network; (F) Computing a price and billing the requester of such mobile user information; (G) Providing the aggregate, anonymized mobile user information to the requester for the purposes of: (1) Advertisement placement decision based on the matching between the aggregate user information and the advertisement target population; (2) Planning transportation routes and/or transportation schedule change decisions; (3) Comparing possible facility sites based on optimization criteria on user mobility patterns; and/or (4) Making available collected mobile user information as customer demographic information.

With respect to providing the aggregate, anonymized mobile user information, such aggregate, anonymized mobile user information may be provided to the requester using any data interchange format that is supported by the service. Such data interchange formats include (but are not limited to) JSON, XML, CSV files, JDBC records, etc.

As described herein, customer demographic information can be collected from mobile devices including, but not limited to, mobile telephones, smart phones, tablets, notebook computers, and/or netbook computers. In another example, the mobile devices may include “wearables” (e.g., APPLE IWATCH, ANDROID WEAR).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method for providing, to an information requester, information associated with a plurality of mobile device users, the method comprising:
collecting, by a processor, from multiple data sources of a mobile network, mobile user information associated with the plurality of mobile device users;
augmenting, by the processor, the collected mobile user information with data from at least one on-demand mobile network service;
anonymizing, by the processor, the augmented mobile user information;
aggregating, by the processor, the anonymized, augmented mobile user information along multiple dimensions to construct customer demographic information;
computing, by the processor, a price for the customer demographic information; and
providing, by the processor, to the requester, the customer demographic information.

2. The method of claim 1, further comprising receiving, by the processor, from the requester, a request for the customer demographic information.

3. The method of claim 1, further comprising enforcing, by the processor, policies regarding use of the mobile user information based on mobile user preferences.

4. The method of claim 1, further comprising billing, by the processor, the requester for the customer demographic information.

5. The method of claim 1, wherein each mobile device is selected from the group comprising: (a) a mobile telephone; (b) a smart phone; (c) a tablet; (d) a notebook computer; (e) a netbook computer; (f) a wearable; or (g) an combination thereof.

6. The method of claim 1, wherein the at least one on-demand mobile network service is selected from the group comprising: (a) deep packet inspection; (b) a user localization; or (c) any combination thereof.

7. The method of claim 1, wherein:
the collecting from multiple data sources comprises collecting historic data from the multiple data sources; and
the at least one on-demand mobile network service provides real-time data.

8. The method of claim 1, wherein the mobile network is a cellular network.
